(19) United States
(12) Patent Application Publication
(10) Pub. No.: US 2007/0291708 A1
(43) Pub. Date: Dec. 20, 2007

(54) Method for reverse link resource assignment

(76) Inventor: Anil M. Rao, Cedar Knolls, NJ (US)

Correspondence Address: Lucent Technologies Inc.;Docket Administrator, Room 3J-219, 101 Crawfords Corner Road, Holmdel, NJ, 07733-3030, US

(21) Appl. No.: 11/455,614

(22) Filed: Jun. 19, 2006

(51) Int. Cl. H04Q 7/24

(52) U.S. Cl. 370/338

(57) ABSTRACT

A method of resource allocation in which resources may be allocated to a mobile station or other transmitting entity for transmitting an initial data packet based on a preamble which indicates a data type to be transmitted by the mobile station. Based on the indicated data type, a determination is made as to whether resources should be allocated for transmission of the initial data packet. If it is determined such resources should be allocated, the mobile station can send the initial data packet before receiving a scheduling grant, thereby expediting transmission of the initial data packet and reducing initial latency.

### FIELD OF THE INVENTION

The present invention relates generally to wireless communication systems and, in particular, to scheduling reverse link packet data transmissions in wireless communication systems.

### BACKGROUND OF THE RELATED ART

Universal Mobile Telecommunication System (UMTS) based wireless communication systems will eventually evolve to a scheduled packet data system using an orthogonal radio interface, such as the well-known Orthogonal Frequency Division Multiple Access (OFDMA) radio interface, for purposes of increasing system capacity. Reverse link transmissions in the packet data system should be scheduled in order to maintain orthogonality. Such scheduling involves signaling messages back and forth between a base station and a mobile station before reverse link packet data transmissions may begin which, in turn, produces initial latency.

Voice services can be provided over the scheduled packet data system in the form of Voice over Internet Protocol (VoIP). However, voice services, including VoIP, are time sensitive. The initial latency is undesirable in time sensitive applications.

FIG. 1 depicts a time chart 100 illustrating a method of allocating resources to a mobile station for reverse link packet data transmission in accordance with the prior art. Data arrives in a buffer of the mobile station. At time t0, the mobile station transmits a selected preamble of known size to a base station over a fixed transmission time interval (TTI) on an access channel, such as a Random Access CHannel (RACH). The preamble indicates to the base station that the mobile station needs resources in order to transmit its data. The mobile station randomly selects the preamble from a set of sixteen (16) preambles. Each preamble is a unique signature sequence, or a sequence of numbers. The set of preambles is chosen such that the individual preambles have low cross correlation with each other. For example, the set of preambles includes Walsh codes or sequences which have low cross correlation with each other. Such low cross correlation allows the preambles to be used in a contention based random access scheme in which more than one mobile station is allowed to transmit a preamble simultaneously using a same frequency allocation. A base station receiving two or more different preambles simultaneously should be able distinguish one from the other due to the low cross correlation.

At time t1, the base station detects the preamble and assigns resources to the mobile station for transmitting a scheduling request. The scheduling request indicates information about the data to be transmitted and/or resources at the mobile station such that resources may be properly allocated for the transmission of the data. For example, the scheduling request may indicate information regarding available transmit power at the mobile station and an amount of data in the buffer. At time t2, the base station transmits to the mobile station an acknowledgement and a resource assignment message. Such acknowledgement and resource assignment message are sent over a control channel, such as an Acquisition Indicator CHannel (AICH). The acknowledgement indicates to the mobile station that its preamble was received by the base station. The acknowledgement comprises information regarding the preamble detected by the base station. Such information enables the mobile station to determine whether the acknowledgement was intended for it. The resource assignment message indicates the resources allocated to the mobile station for sending a scheduling request. The scheduling request is a message of predetermined size. Thus, the transmission time interval and bandwidth necessary for the transmission of the scheduling request are known by the base station, and the resource assignment message need only indicate time and frequency resources allocated to the mobile station.

At time t3, the mobile station receives the acknowledgement and resource assignment message. The mobile station determines the acknowledgement as intended for itself using the information contained therein. At time t4, the mobile station transmits the scheduling request.

At time t5, the base station receives the scheduling request and allocates specific resources to the mobile station based on the scheduling request. At time t6, the base station transmits a scheduling grant indicating the allocated resources. The scheduling grant is transmitted over a control channel, such as Enhanced Absolute Grant CHannel (E-AGCH). The scheduling grant includes information regarding the resources being allocated and a mobile station identifier for indicating the mobile station to which resources are being allocated. At time t7, the mobile station receives the scheduling grant. The mobile station begins transmitting its data at time t8 using the resources indicated in the scheduling grant. At time t9, the base station begins receiving the data.

The multiple steps involved in allocating resources for the initial data packet transmission produce an initial latency with respect to transmission of an initial data packet. Such initial latency is undesirable in time sensitive applications, such as VoIP applications. In VoIP, the initial latency can increase conversational delay, which corresponds to a time interval from when a first mobile user stops talking to when the first mobile user starts to hear a second mobile user talking. Increased conversational delay can cause undesirable results, such as the first and second mobile users speaking over each other or perceiving the connection to be poor. Thus, it is desirable to send the initial data packet from the second mobile user as quickly as possible in order to reduce the initial latency and conversational delay.

One solution to reducing the initial latency would be to transmit the scheduling request along with the preamble for VoIP and similar time sensitive applications. Such solution would either require lengthening the TTI on the access channel in order to accommodate the scheduling request, or to shorten the preamble such that the scheduling request and preamble can be transmitted over the original length TTI. However, not all applications are time sensitive. The initial latency is not a concern in non-time sensitive applications and, thus, the scheduling request does not need to be sent with the preamble to reduce initial latency. Lengthening the TTI for all transmissions on the access channel, including transmissions associated with non-time sensitive applications, would therefore be an inefficient utilization of the access channel. Furthermore, shortening the preamble is also undesirable because it may degrade the performance of preamble detection at the base station.

Accordingly, there exists a need to reduce the initial latency associated with reverse link packet data transmissions without sending the scheduling request along with the preamble.

### SUMMARY OF THE INVENTION

An embodiment of the present invention is a method of resource allocation in which resources may be allocated to a mobile station or other transmitting entity for transmitting an initial data packet based on a preamble which indicates a data type to be transmitted by the mobile station. Based on the indicated data type, a determination is made as to whether resources should be allocated for transmission of the initial data packet. If it is determined such resources should be allocated, the mobile station can send the initial data packet before receiving a scheduling grant, thereby expediting transmission of the initial data packet and reducing initial latency.

In one embodiment, the method of resource allocation comprises the steps of receiving a preamble indicating a data type and allocating resources based on the preamble. If the data type is associated with a time sensitive application, then resources may be allocated for the transmission of an initial data packet and a scheduling request. If the data type is associated with a non-time sensitive application, then resources may be allocated for the transmission of the scheduling request.

### BRIEF DESCRIPTION OF THE DRAWINGS

The features, aspects, and advantages of the present invention will become better understood with regard to the following description, appended claims, and accompanying drawings where:

FIG. 1 depicts a time chart illustrating a method of allocating resources to a mobile station for reverse link packet data transmission in accordance with the prior art;

FIG. 2 depicts a wireless communication system used in accordance with an embodiment of the present invention; and

FIG. 3 depicts a flowchart illustrating a method of allocating resources to a mobile station for reverse link packet data transmissions in accordance with an embodiment of the present invention.

### DETAILED DESCRIPTION

An embodiment of the present invention is a method of resource allocation in which resources may be allocated to a mobile station or other transmitting entity for transmitting an initial data packet based on a preamble which indicates a data type to be transmitted by the mobile station. Based on the indicated data type, a determination is made as to whether resources should be allocated for transmission of the initial data packet. If it is determined such resources should be allocated, the mobile station can send the initial data packet before receiving a scheduling grant, thereby expediting transmission of the initial data packet and reducing initial latency.

For purposes of discussion, the present invention will be discussed herein with reference to a wireless communication system based on the well-known Universal Mobile Telecommunication System (UMTS) standard. This should not be construed to limit the present invention in any manner. It should be apparent to a person of skill in the art to apply to the present invention to a wireless communication system based on some other radio interface.

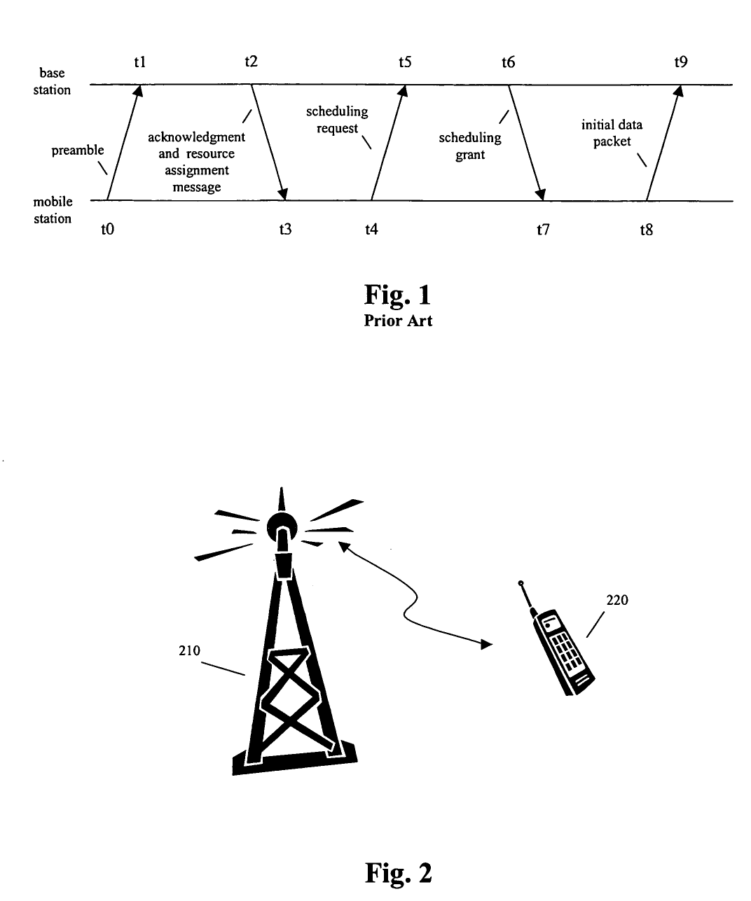

FIG. 2 depicts a wireless communication system 200 used in accordance with an embodiment of the present invention. Wireless communication system 200 comprises a base station 210 and a mobile station 220. Packet data transmissions from mobile station 220 to base station 210, i.e., reverse link, are scheduled in wireless communication system 200. Such scheduling requires the allocation of resources, such as frequency, bandwidth, transmission times, etc., prior to transmitting an initial data packet.

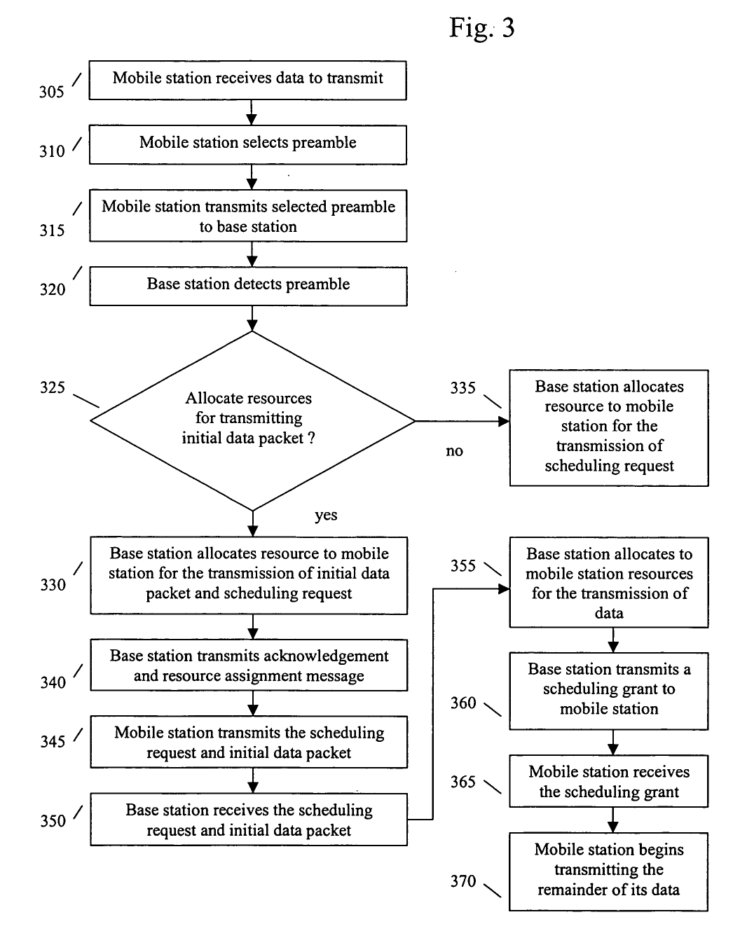

FIG. 3 depicts a flowchart 300 illustrating a method of allocating resources to mobile station 220 for reverse link packet data transmissions in accordance with an embodiment of the present invention. In step 305, mobile station 220 receives data to transmit. The data is stored in a buffer at mobile station 220. In step 310, mobile station 220 selects a preamble based on a type of the data in its buffer. The preamble is a unique signature sequence or a sequence of numbers which indicates to the base station that the mobile station needs resources in order to transmit its data. In accordance with an embodiment, the preamble further indicates a data type, which will be described later herein.

In one embodiment, mobile station 220 selects the preamble from a set of preambles. The set of preambles may include preambles which have low cross correlation with each other. For example, the set of preambles includes Walsh codes or sequences which have low cross correlation with each other. Such low cross correlation allows the preambles to be used in a contention based random access scheme in which more than one mobile station is allowed to transmit a preamble simultaneously using a same frequency allocation. A base station receiving two or more different preambles simultaneously should be able distinguish one from the other.

The set of preambles may be partitioned into two or more preamble classes. Each preamble class corresponds to a data type, which may be defined based on one or more data characteristics. In one embodiment, the data types are defined based on an initial data packet size and a latency constraint which indicates an amount of tolerable initial latency. For example, one data type might be Voice over Internet Protocol (VoIP) using a 7.95 kbps Adaptive Multi-Rate (AMR) vocoder. The data packet size would be 216 bits comprising a 192 bit speech frame and a 3 byte compressed header. The latency constraint may be set to 20 ms to 40 ms. Another data type might be Session Initiated Protocol (SIP) messages used in push-to-talk applications. The initial SIP message is known as an SIP INVITE message. This message is approximately 500 bytes depending on the vocoder used. The latency constraint may be set to 500 ms. In one embodiment, mobile station 220 may determine a preamble class corresponding to the data type and then randomly (or non-randomly) selects a preamble from that preamble class.

In step 315, mobile station 220 transmits the selected preamble to base station 210 over a fixed transmission time interval (TTI) on an access channel, such as a Random Access CHannel (RACH). In step 320, base station 210 detects the preamble. In step 325, base station 210 determines whether to allocated resources and, if applicable, how much resources, to mobile station 220 for the transmission of an initial data packet based on the detected preamble. In one embodiment, such determination is based on the preamble class associated with the detected preamble. For example, if the preamble class corresponds to a data type associated with VoIP using a 7.95 AMR vocoder, then base station 210 determines to allocate resources to mobile station 220 for the transmission of the initial data packet of 216 bits. If the preamble class corresponds to a data type associated with SIP messages used in push-to-talk applications, then base station 210 determines to allocate resources to mobile station 220 for the initial data packet of 500 bytes. Or if the preamble class corresponds to a data type associated with a non-time sensitive application, then base station 210 does not allocate resources to mobile station 220 for the transmission of an initial data packet.

Note that, in another embodiment, resources may be allocated for the transmission of an initial data packet even though the data is not associated with a time sensitive application. The amount of resources allocated in this instance may be a default initial data packet size.

If resources are to be allocated, flowchart 300 continues to step 330 where base station 210 allocates resource to mobile station 220 for the transmission of the initial data packet and a scheduling request. The scheduling request indicates information about the data to be transmitted and/or resources at the mobile station such that resources may be properly allocated for transmission of the data. For example, the scheduling request may include information regarding available transmit power at the mobile station and an amount of data in the buffer. Otherwise, flowchart 300 continues to step 335 where base station 210 allocates resources to mobile station 220 for the transmission of the scheduling request.

Resources for the transmission of the scheduling request and initial data packet are allocated to mobile stations 220 based on the known sizes of the scheduling request and initial data packet. The size of the scheduling request is predetermined. The initial data packet is known by mobile station 220 and may be determined by base station 210 using the detected preamble, e.g., preamble class indicates size of initial data packet.

Note that by associating the preamble with a data type, the preamble may indicate a request for resource allocation for the transmission of the initial data packet. Base station 220 can allocate resources for the transmission of the initial data packet prior to receiving the scheduling request, thereby reducing initial latency. No additional messages need to be sent with the preamble in order to convey a request for resource allocation for the transmission of the initial data packet.

From steps 330 and 335, flowchart 300 continues to step 340 where base station 210 transmits an acknowledgement and a resource assignment message. Such acknowledgement and resource assignment message are sent over a control channel, such as an Acquisition Indicator CHannel (AICH). The acknowledgement indicates to the mobile station that its preamble was received by the base station. The acknowledgement comprises information regarding the preamble detected by the base station. Such information enables the mobile station to determine whether the acknowledgement was intended for it. The resource assignment message indicates the resources allocated to the mobile station for sending its scheduling request and, if applicable, its initial data packet. As mentioned earlier, the sizes of the scheduling request and initial data packets are known by both base station 210 and mobile station 220. Accordingly, the resource assignment message need only indicate time and frequency resources allocated to mobile station 220. In one embodiment, the acknowledgement and resource assignment message are sent together, in a known sequence, over the control channel.

Note that if an acknowledgement is not received by mobile station 220 within some predetermined or randomly determined time period, it may be assumed that base station 210 did not detect the preamble. In such as situation, mobile station 220 may repeat step 315 and transmit another preamble or the same preamble.

In step 345, mobile station 220 transmits the scheduling request and initial data packet using the allocated resources indicated in the resource assignment message. In one embodiment, the scheduling request and initial data packet are transmitted together, in a known sequence, over a shared reverse link data channel, such as an Uplink Shared CHannel (UL-SCH). In step 350, base station 210 receives the scheduling request and initial data packet. In step 355, base station 210 allocates to mobile station 220 resources for the transmission of data based on the scheduling request. In step 360, base station 210 transmits a scheduling grant to mobile station 220 over a control channel, such as the Enhanced Absolute Grant CHannel (E-AGCH). The scheduling grant may indicate information regarding the resources being allocated and a mobile station identifier for indicating the mobile station to which resources are being allocated. Or the scheduling grant may indicate the time and frequency resources allocated to mobile station 220. In step 365, mobile station 220 receives the scheduling grant. In step 370, mobile station 220 begins transmitting the remainder of its data using the allocated resources.

In step 315, the preamble is transmitted by mobile station 220 at a preamble power level. The preamble power level may be determined using a broadcast message transmitted over a broadcast channel from base station 210. The broadcast message includes information regarding an uplink interference level and a signal-to-interference ratio (SIR) target for the preamble. In one embodiment, mobile station 220 sets the preamble power level to achieve the SIR target at base station 210 based on the broadcast message and an estimate of path loss between mobile station 220 and base station 220. For example, preamble transmit power is set equal to SIR target plus uplink interference level minus path loss. In another embodiment, mobile station 220 boosts the preamble power level to achieve a certain power level above the SIR target at base station 210. For example, preamble transmit power is set equal to SIR target plus uplink interference level minus path loss plus desired margin above SIR target. By boosting the preamble power level, detection of the preamble should be facilitated at base station 210.

Although the present invention has been described in considerable detail with reference to certain embodiments, other versions are possible. For example, the mobile station and base station may be another type of transmitting and receiving entity, or the resource allocation can be applied to forward link packet data transmissions. Therefore, the spirit and scope of the present invention should not be limited to the description of the embodiments contained herein.

1. A method of resource allocation comprising the steps of:
detecting a preamble indicating a data type; and
allocating resources to a transmitting entity based on the preamble.

2. The method of claim 1, wherein the data type indicates whether data to be transmitted is associated with a time sensitive application.

3. The method of claim 1, wherein the data type indicates an initial data packet size for the data to be transmitted.

4. The method of claim 1, wherein resources are allocated to the transmitting entity for transmissions of a scheduling request and an initial data packet.

5. The method of claim 4 comprising the additional steps of:
transmitting resource assignment message indicating the resources allocated for the transmissions of the scheduling request and the initial data packet;
receiving the scheduling request and the initial data packet, wherein the scheduling request indicates information about the data to be transmitted and/or resources at the mobile station such that resources may be properly allocated for transmission of data; and
transmitting a scheduling grant indicating resources allocated based on the scheduling request.

6. The method of claim 1, wherein resources are allocated to the transmitting entity for transmission of a scheduling request.

7. The method of claim 6 comprising the additional steps of:
transmitting resource assignment message indicating the resources allocated for the transmission of the scheduling request;
receiving the scheduling request and the initial data packet, wherein the scheduling request indicates information about the data to be transmitted and/or resources at the mobile station such that resources may be properly allocated for transmission of data; and
transmitting a scheduling grant indicating resources allocated based on the scheduling request.

8. The method of claim 1 comprising the additional step of:
receiving subsequent data packets over the allocated resources indicated in the scheduling grant.

9. A method of operating a transmitter in a wireless communication system comprising the steps of:
selecting a preamble indicating a type of data to be transmitted;
transmitting the selected preamble; and
receiving a resource assignment message indicating resources allocated based on the preamble.

10. The method of claim 9, wherein resources assignment message indicates resources allocated for transmission of a scheduling request or resources allocated for transmission of the scheduling request and an initial data packet

11. The method of claim 10, wherein the resource assignment message indicates resources allocated for the transmission of the scheduling request and the initial data packet if the type of data to be transmitted is associated with a time sensitive application.

12. The method of claim 11 comprising the additional step of:
transmitting the scheduling request and initial data packet using the allocated resources.

13. The method of claim 12 comprising the additional step of:
receiving a scheduling grant in response to the scheduling request, the scheduling grant indicating resources allocated for transmitting the data; and
transmitting the data using the allocated resources indicated in the scheduling grant.

14. The method of claim 10, wherein the resource assignment message indicates resources allocated for the transmission of the scheduling request if the type of data to be transmitted is associated with a non-time sensitive application.

15. The method of claim 9, wherein the step of selecting the preamble comprises the steps of:
determining a preamble class based on the type of data to be transmitted; and
selecting a preamble belonging to the determined preamble class.

16. The method of claim 15, wherein the preamble is randomly selected from the determined preamble class.

17. The method of claim 9, wherein the selected preamble is transmitted at a power level based on an uplink interference level and a signal-to-interference ratio target.

18. The method of claim 9, wherein the selected preamble is transmitted at a power level that should be received at a signal-to-interference target by a receiving entity.

19. The method of claim 9, wherein the selected preamble is transmitted at a power level that should be received at a desired margin above a signal-to-interference target at a receiving entity.
